(19) United States
(12) Patent Application Publication
(10) Pub. No.: US 2007/0199215 A1
(43) Pub. Date: Aug. 30, 2007

(54) Animal Ear Tag

(76) Inventors: Michael Stuart Gardner, Auckland (NZ); Roy Victor Bladen, Auckland (NZ)

Correspondence Address: HENRICKS SLAVIN AND HOLMES LLP;SUITE 200, 840 APOLLO STREET, EL SEGUNDO, CA, 90245, US

(21) Appl. No.: 11/573,688

(22) PCT Filed: Aug. 16, 2005
(86) PCT No.: PCT/NZ05/00211

§ 371 Date: Feb. 13, 2007

(30) Foreign Application Priority Data
Aug. 17, 2004 (NZ) 534789

(51) Int. Cl. G09F 3/00

(52) U.S. Cl. 40/301

(57) ABSTRACT

The male portion 1 of an animal tag has a stem 3 and a base portion 4 extending to core portion 4A which is of a softer material than the partial shell of harder material defining an outer surface 6 of a tip 7 of head 5. When the head 5 engages an opening 10 of a female tag 11 of rigid material, the partial shell 6 of hard material is able to compress around the softer mate core 4A in a direction indicated by arrows Y and around the vertical axis X-X. In doing so the head 5 does not lose its essentially circular cross section so that entry through the circular opening 10 of the female tag 1 1 is not hindered.

### BACKGROUND OF THE INVENTION

The present invention relates to animal tags and in particular to a male tag which is intended in use to be insertable through an animal's ear for engagement with a female tag.

The present invention will be described hereinafter in respect of a two piece tag i.e. one in which the male and female tags are separate. However, it will be understood that the present invention could be used with a single piece tag in which the male and female tags are interconnected.

To the present time male tags have been available with a variety of designs. A very efficient male tag design, for example is disclosed in my U.S. Pat. No. 6,546,652, in which the tip of the male tag is in the form of a partial half cone which defines a chamfered or cut-away edge. This male tag is adapted to be used with a female tag which includes an insert of a material which is the same hardness or softer than the material forming the chamber in which the insert is accommodated. Because of the hardness of its tip, that male tag relies on the expansion of the female tag for its insertion so the female tag could not itself be of a rigid material.

In my U.S. Pat. No. 6,405,462 there is also disclosed a male tag which has a pyramidal tip of hard material and a base of a softer material. The tip of this tag is able to compress on entry into the female tag but does so about a horizontal plane and being a pyramid does not achieve “roundness” on compression for it to enter the round hole of a rigid female tag.

In other designs of male tag presently available some rely on a hard tip at the top of the head which is punched through an animal's ear. Due to the large diameter of hard material at the front and that of the soft material behind it being forced through, such male tags tend to cause a large wound in the animal's ear resulting in both pain to the animal at the time of insertion and a greater risk of infection. In U.S. Pat. No. 6,021,592 (Caisley), for example, a conical cutting body of hard material is embedded in a softer material behind it. The design of that cutting body would permit minimal compression of it as it engages with the female tag.

### OBJECTS OF THE INVENTION

It is an object of a preferred embodiment of the present invention to provide an animal tag having a male portion with an improved ability to penetrate through an animal's ear and to engage with a female tag of hard material, or which at least will provide the public with a useful choice.

Further objects of this invention will become apparent from the following description.

### SUMMARY OF THE INVENTION

According to one aspect of the present invention there is provided an animal tag including a male portion having a longitudinal axis, a stem extending substantially along said axis, and an enlarged head, the head including a tip portion and a base portion, the base portion being provided of a first material and the tip portion being provided of a second material harder than the first material, the harder material extending in the direction of said longitudinal axis from the tip portion towards the base portion and to define a partial shell therearound, said harder material including a plurality of cutting edges to facilitate the penetration of the male portion through an animal's ear, said partial shell of said harder material being adapted to be compressible about said longitudinal axis to facilitate, in use, the entry of said male portion through an opening of a female portion of hard material.

Preferably the harder material defines a partial cone for at least part of its length and having at least a pair of spaced apart said cutting edges.

Preferably the harder material includes a recessed or scalloped area defining a further pair of opposed said cutting edges.

Preferably the harder material is a hard plastics material and the softer material is polyurethane.

Preferably the softer material is thermoplastic polyurethane (TPU).

Preferably the hard plastics material is a polyester-based thermoplastic polyurethane.

Preferably the harder material is formed into at least one face and said softer material is moulded thereover so as to provide a bonding between the harder and the softer material.

According to a still further aspect of the present invention there is provided an animal tag including a male portion substantially as herein described with reference to the accompanying drawings, (excluding FIG. 3(a)).

Further aspects of this invention which should be considered in all its novel aspects will become apparent from the following description given by way of example of possible embodiments and in which reference is made to the accompanying drawings.

### BRIEF DESCRIPTION OF THE DRAWINGS

FIG. 1: Shows a front view of an animal tag according to one possible embodiment of the invention;

FIG. 2: Shows a side perspective view of the tag of FIG. 1;

FIGS. 3a & b: Show very diagrammatically in FIG. 3a a prior art tag in use and in FIG. 3b, a tag according to the present invention in use.

FIG. 4: Shows diagrammatically the compression of the tip portion of a male tag according to one embodiment of the invention about its longitudinal axis on entry through a hard female tag.

### BRIEF DESCRIPTION OF POSSIBLE EMBODIMENTS

The present invention seeks to provide an animal tag, the male portion of which has improved penetration through an animal's ear so as to provide for a substantially small and clean cut and an improved ability to engage with a female tag of a hard material. In this way the tag of the present invention would be particularly suitable for use with smaller animals but its use is not intended to be restricted to any size of animal. However, most importantly, the male portion would have an improved ability to engage with numerous types of female tags, such as those of RFID tags, which are necessarily of a very rigid material. In the case of such RFID tags this is to provide the necessary protection for the electronic devices or circuits such as transponders.

The present invention also seeks to provide, at least in its preferred embodiment, a male tag which is able to be used with a variety of types of female tags and in particular those which may include a chamber or insert which is not required to be of a specific hardness of material relative to the material of the male tag. In that regard some previous male/female tag combinations have required the female tag insert or chamber to be of a particular hardness to enable the retention within it of the male tag. The present invention is envisaged as being used with female tags incorporating softer or harder material.

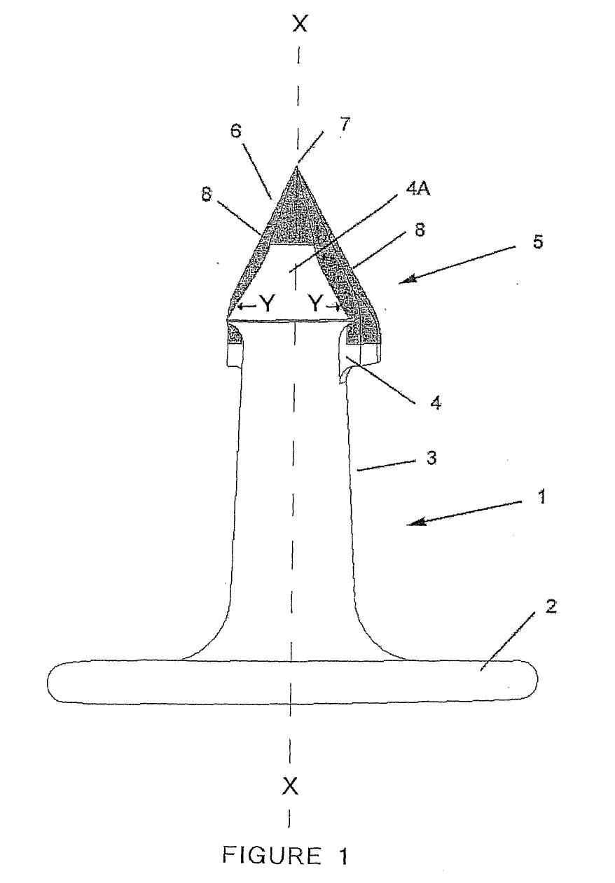

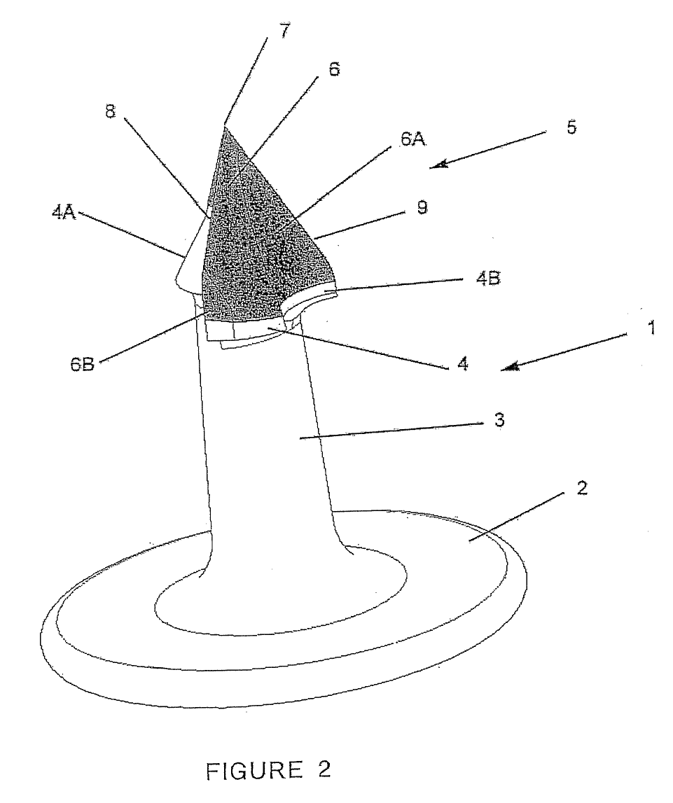

Turning now to the accompanying drawings and particularly FIGS. 1 and 2 a male tag 1 is shown in this embodiment as being a single piece tag which in use will be used with a single piece female tag, although in alternative embodiments a one piece male/female tag could be provided.

The male tag 1 is shown with an enlarged button or label area 2 which on its exposed outer surface could include suitable indicia for identifying a particular animal and/or could include a suitable transponder or like means, if required, as part of an RFID tag.

Extending from a distal end of a stem 3 is shown a button or the like 2. This will suitably be hollow so as to enable the pin of an applicator to be inserted therethrough when the male tag 1 is being inserted through an animal's ear. The stem 3 extends to a base portion 4 of a head portion 5 and along a longitudinal axis identified as X-X. The base portion 4 is shown of a material which extends upwardly into an upper area 4A forming a core within the head 5 and about which a second material extends substantially vertically, at least in part, to define one or more outer surfaces 6 extending up to a tip 7. The material of the base portion 4/4A will be of a softer material than that of the outer surface 6. Suitably the material 4/4A may be a plastic such as thermoplastic polyurethane (TPU). The material of the surface 6/tip 7 may be a suitably harder material such as a hard polyester-based thermoplastic polyurethane, such as ESTANE™ X-4995 manufactured by Noveon.

Suitably the harder material may define very approximately about 50% of the total material of the head portion 5. As shown the harder material of the tip portion 7 effectively provides a partial shell 6 around the softer material of the base portion 4A and about the vertical axis X-X and in the form of a partial cone.

Importantly the harder material of the partial shell surface 6 is shown extending from at or adjacent the bottom of the head 5 to form the tip 7. The harder material is also shown in FIG. 1 defining a pair of cutting edges 8. The harder material 6 is also shown in FIG. 2 as having a recessed or scalloped face 6A defining a pair of opposed cutting edges 9.

It is seen that a portion 4B of the softer material is in this embodiment left exposed along the edge of the base portion 4 and beneath the bottom edge of the harder material 6. The substantially vertical combination of the harder and softer materials contributes to their ability to stay together and not get stripped off in use, but also has a major additional advantage which is referred to below.

A flattened area 6B may also be provided on either side of the head portion 5 adjacent the base portion 4, which may assist the insertion of the male tag into the female tag and/or its retention therein.

In manufacturing the tag 1 the surface(s) 6 of hard material will be created by a suitable process and in a preferred embodiment moulded from a polyester-based thermoplastic polyurethane, although any other suitable material may be used.

The softer material such as TPU, of the base 4, stem 3 and button 2, may then be over moulded so that with the appropriate temperature selections a bonding can be created between the harder and the softer materials. It is envisaged that to improve the interlocking between the harder and the softer materials the surfaces(s) 6 could be provided with one or more areas into which the softer material will be able to flow. It will be appreciated that as the harder material extends from the tip 7 to be at or adjacent the base 4, forces imposed on the tip 7 during its penetration through an animal's ear will be able to be transmitted through the harder material. The tag of the present invention thereby will provide for a more rigid structure.

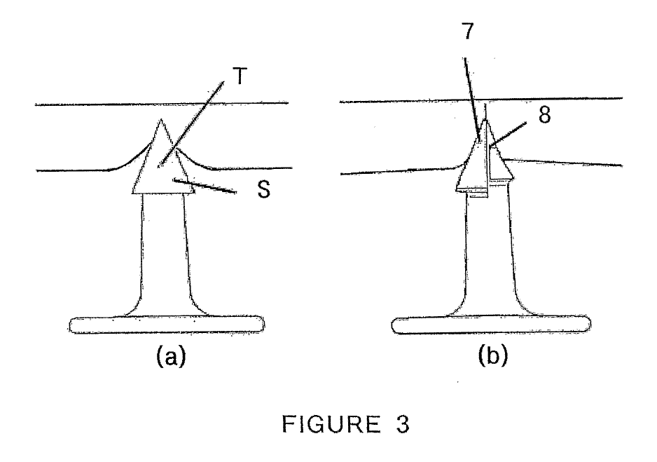

This is illustrated in FIG. 3 where in FIG. 3a a prior art tag is shown with its hard tip T being forced into the animal's ear E so that penetration through the animal's ear E will rely on the pushing of the tip T through the ear E, followed by the softer materials S. It will be apparent that a relatively large and damaged entry point will be the result, as well as increased pain to the animal.

In contrast, in FIG. 3(b) the tag of the present invention, due to the improved rigidity of its tip 7 and its improved cutting edges such as 8, is able to create a clean hole in the animal's ear so that both the size and damage of the entry point is minimised, making this tag particularly suitable for smaller animals.

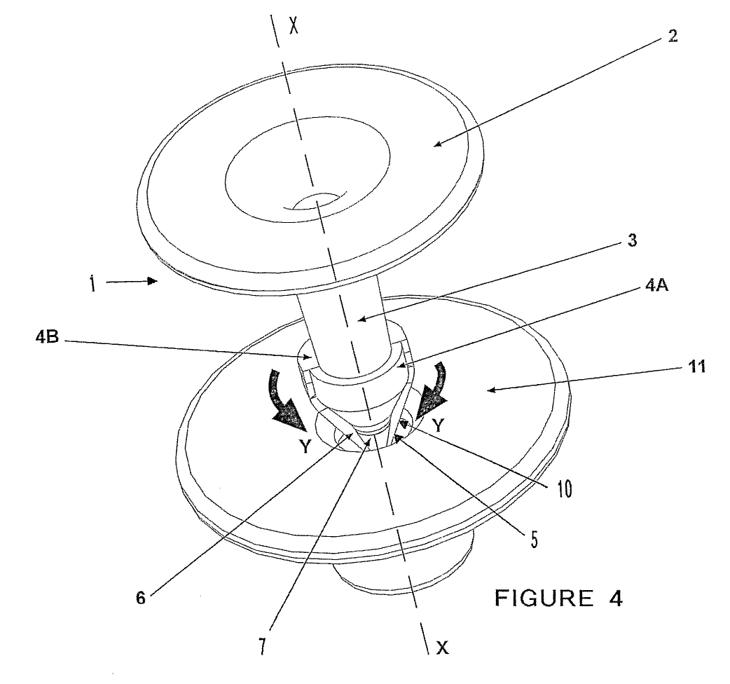

Referring now particularly to FIGS. 1 and 4, it is seen that as the head 5 engages with the opening 10 of a female tag 11 of a rigid material, the partial shell 6 of hard material is able to compress around the softer material core 4A, in a direction indicated by arrows Y and around the vertical axis X-X. In doing so the head 5 does not lose or substantially lose its “roundness” or essentially circular cross section. Accordingly its entry through the circular opening 10 of the female tag 11 is not hindered. In contrast, it will be appreciated that male tags which do not have the ability to compress, or which, not having a circular cross section, compress about a horizontal plane, are difficult, if not impossible, to be inserted into a circular opening of a rigid female tag.

Wherein the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. An animal tag including a male portion having a longitudinal axis, a stem extending substantially along said axis, and an enlarged head, the head including a tip portion and a base portion, the base portion being provided of a first material and the tip portion being provided of a second material harder than the first material, the harder material extending in the direction of said longitudinal axis from the tip portion towards the base portion and to define a partial shell therearound, said harder material including a plurality of cutting edges to facilitate the penetration of the male portion through an animal's ear, said partial shell of said harder material being adapted to be compressible about said longitudinal axis to facilitate, in use, the entry of said male portion through an opening of a female portion of hard material.

2. An animal tag as claimed in claim 1 wherein the harder material defines a partial cone for at least part of its length and having at least a pair of spaced apart cutting edges.

3. An animal tag as claimed in claim 1 wherein the harder material includes a recessed or scalloped area defining a further pair of opposed said cutting edges.

4. An animal tag as claimed in claim 1 wherein the harder material is a hard plastics material and the softer material is polyurethane.

5. An animal tag as claimed in claim 1 wherein the softer material is a thermoplastic polyurethane (TPU).

6. An animal tag as claimed in claim 4 in which the hard plastics material is a polyester-based thermoplastic polyurethane.

7. An animal tag as claimed in claim 1 wherein the harder material is formed into at least one face and said softer material is moulded thereover so as to provide a bonding between the harder and the softer material.

8. An animal tag as claimed in claim 1 wherein the stem at an end distal from said head includes an enlarged portion.

9. An animal tag as claimed in claim 8 in which the enlarged portion is in the form of a button.

10. An animal tag as claimed in claim 1 further including a female portion of a hard material, an opening in said female portion being adapted to engageably receive said enlarged head therethrough and adapted to cause the compression of said partial shell of said harder material about said longitudinal axis, said opening and said enlarged head after compression both being of a substantially circular cross section.

11-12. (canceled)
